(19) United States
(12) Patent Application Publication
(10) Pub. No.: US 2015/0206156 A1
(43) Pub. Date: Jul. 23, 2015

(54) SURVEY MANAGEMENT SYSTEMS AND METHODS WITH NATURAL LANGUAGE SUPPORT

(71) Applicants: Jason Tryfon, Milton (CA); Samuel Oosterhuis, Guelph (CA)

(72) Inventors: Jason Tryfon, Milton (CA); Samuel Oosterhuis, Guelph (CA)

(21) Appl. No.: 14/159,433

(22) Filed: Jan. 20, 2014

(51) Int. Cl. G06Q 30/02; G06F 17/28

(52) U.S. Cl. CPC G06Q 30/0203; G06F 17/28

(57) ABSTRACT

Systems and methods for processing natural language survey responses are provided herein. Methods may include providing to a client a survey that comprises questions which are designed to elicit responses from a customer regarding customer satisfaction with a product, service, or provider, wherein the survey includes a graphical user interface for displaying the questions, the GUI comprising a speech input interface for at least one question, receiving from a client a natural language response for the at least one question, performing a textual analysis of the natural language response to determine textual content and a sentiment for the natural language response, and returning to the client the textual content, which is displayed on the GUI proximate the at least one question.

### FIELD OF THE TECHNOLOGY

Embodiments of the disclosure relate to natural language processing and survey response management, and more specifically, but not by way of limitation to systems and methods for processing natural language survey responses using a survey response system in order to determine customer sentiments from natural language responses and elicit more comprehensive responses from customers.

### BACKGROUND OF THE DISCLOSURE

The survey process is often integral to a company who desires to receive feedback from their customers regarding the company, employees, products/services, or customer service. Surveys questions are typically tailored to elicit responses to the various topics described above. Further, these questions are designed to engage the customer by being short and directed. In some instances, questions are coupled with pre-defined and selectable responses that ensure ease of use. Indeed, customers may not complete surveys that are difficult or cumbersome to utilize. Additionally, due to the nature of the survey questions, it is often impossible to ask a sufficient amount of relevant questions to uncover all possible negative customer experiences.

### SUMMARY OF THE DISCLOSURE

According to some embodiments, the present technology may be directed to a method for processing natural language survey responses using a survey response system that comprises a processor and a memory for storing logic, the processor executing the logic to perform the method. The method comprises: (a) providing to a client a survey that comprises questions which are designed to elicit responses from a customer regarding customer satisfaction with a product, service, or provider, wherein the survey includes a graphical user interface for displaying the questions, the GUI comprising a speech input interface for at least one question; (b) receiving from a client a natural language response for the at least one question; (c) performing a textual analysis of the natural language response to determine textual content and a sentiment for the natural language response; and (d) returning to the client the textual content, which is displayed on the GUI proximate the at least one question.

According to other embodiments, the present technology may be directed to a system for processing natural language survey responses, the system comprising: (a) a processor; and (b) a memory for storing logic that when executed by the processor causes the system to: (i) providing to a client a survey that comprises questions which are designed to elicit responses from a customer regarding customer satisfaction with a product, service, or provider, wherein the survey includes a graphical user interface for displaying the questions, the GUI comprising a speech input interface for at least one question; (ii) receiving from a client a natural language response for the at least one question; (iii) performing a textual analysis of the natural language response to determine textual content and a sentiment for the natural language response; and (iv) returning to the client the textual content, which is displayed on the GUI proximate the at least one question.

According to some embodiments, the present technology is directed to a graphical user interface (GUI) generated by a computing device that comprises a processor and a memory for storing logic. The processor executes the logic to generate the GUI that comprises: (a) a series of survey questions designed to elicit responses that are indicative of customer experiences; (b) a speech input interface disposed in proximity to one or more of the series of survey questions, the speech input interface triggering a speech recording function of the computing device; and (c) a text display object associated with the speech input interface, the text display object providing textual content extracted from natural language responses recorded by the computing device.

According to other embodiments, the present technology may be directed to a non-transitory computer readable storage media that includes logic that is executed by a processor to perform a method. The method comprises: (a) providing to a client a survey that comprises questions which are designed to elicit responses from a customer regarding customer satisfaction with a product, service, or provider, wherein the survey includes a graphical user interface for displaying the questions, the GUI comprising a speech input interface for at least one question; (b) receiving from a client a natural language response for the at least one question; (c) performing a textual analysis of the natural language response to determine textual content and a sentiment for the natural language response; and (d) returning to the client the textual content, which is displayed on the GUI proximate the at least one question.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is an exemplary computing architecture comprising a survey response system that may be used to practice aspects of the present technology;

FIG. 2 is a graphical user interface in the form of a dashboard for displaying survey metrics and analytics regarding natural language survey responses;

FIG. 3 is a graphical user interface in the form of a survey that comprises a series of survey questions;

FIG. 4 the GUI of FIG. 3 illustrating a speech input interface associated with one of the series of survey questions;

FIG. 5 the GUI of FIGS. 3 and 4, illustrating the speech input interface and various control mechanisms therefore;

FIG. 6 illustrates various views of the GUIs of FIGS. 3-5 in a mobile format;

FIG. 7 is a flowchart of another exemplary method for building contextual properties in accordance with a contextual vocabulary; and

FIG. 8 illustrates an exemplary computing system that may be used to implement embodiments according to the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

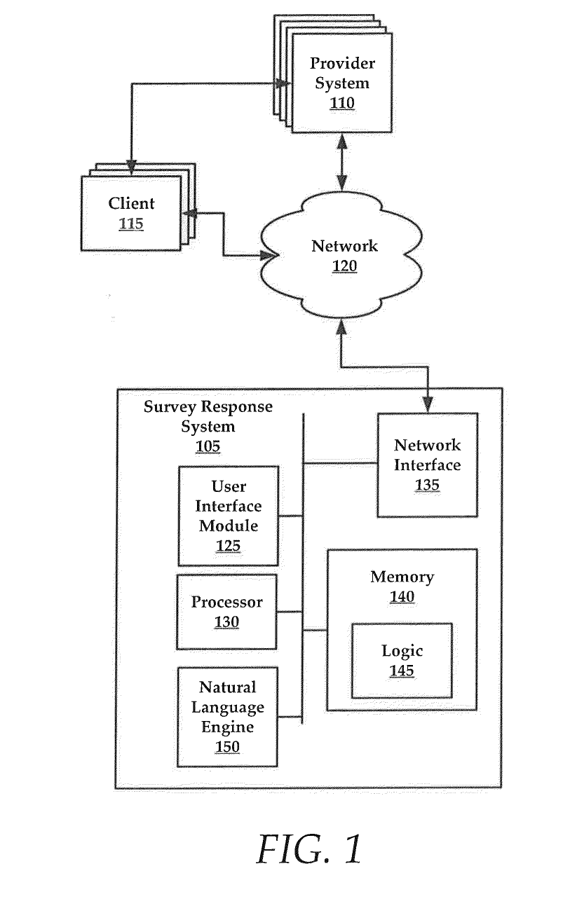

FIG. 1 illustrates an exemplary architecture for practicing aspects of the present technology. The architecture comprises a survey response system, hereinafter “system 105” that is broadly configured to provide speech-to-text features for mobile surveys, as well as analytical information related to such surveys. Generally the system 105 is configured to communicate with client devices, such as client 115. The client 115 may include, for example, a Smartphone, a laptop, a computer, or other similar computing device. An example of a computing device that can be utilized in accordance with the present invention is described in greater detail with respect to FIG. X.

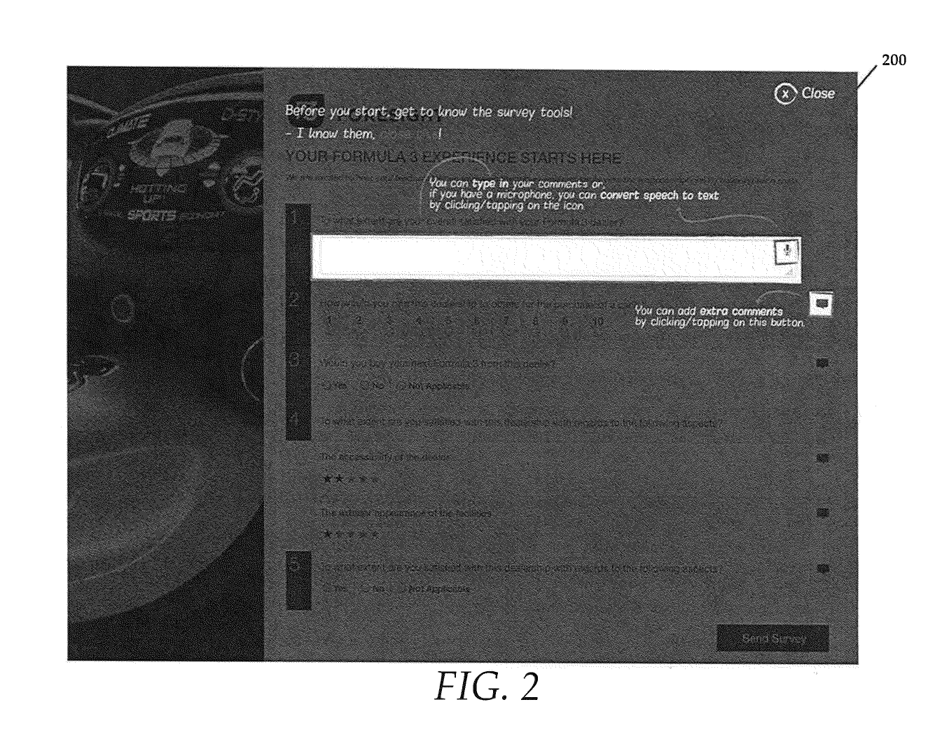

According to some embodiments, the client 115 is configured to execute a mobile survey application that resides on the client 115. In other instances the client 115 may access a web-based version of the survey application via a web browser client application. Various mobile GUIs are illustrated in FIGS. 2-6, which will be described in greater detail below.

The system 105 may communicatively couple with the client 115 and provider systems 110 via a public or private network 120 using a network interface 135. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

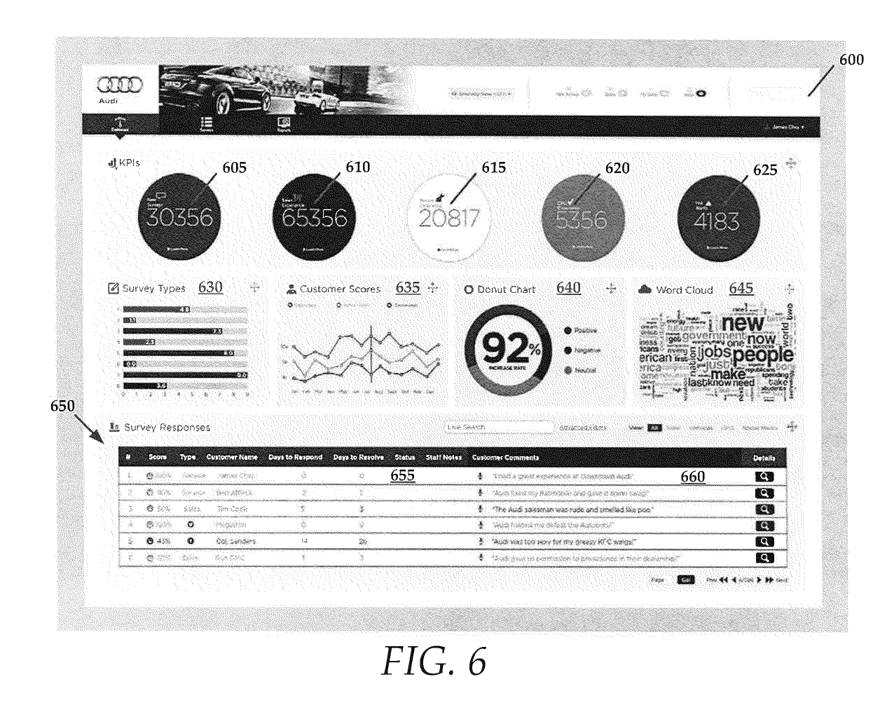

Provider systems 110 may also include a wide variety of computing systems that are configured to allow providers such as merchants to interact with the system 105. In some instances the system 105 provides a provider system with GUIs in the form of dashboards that include metrics regarding natural language responses to survey questions entered as spoken natural language input by survey responders. For example, a dashboard may include a calculation of customer sentiment values in terms of the provider, a good or service, the provider's customer service, and/or employees—just to name a few. An example of a provider dashboard is illustrated in FIG. 6, which will be described in greater detail below.

The system 105 generally comprises a user interface module 125, a processor, 130, a network interface 135, a memory 140, logic 145, and a natural language engine 150. According to some embodiments, the memory 140 executes logic 145 to perform operations and methods such as the distribution of surveys to the client 115, receipt and processing of natural language responses, generation of GUIs such as dashboards that include metrics and analytics calculated from received natural language response, and other features which will be described in greater detail herein.

In some embodiments, the client 115 may itself receive and process natural language responses to survey questions. In other embodiments, natural language responses to questions may be recorded by the client 115 and uploaded to the system 105 for processing by the natural language engine 150. Also, the client 115 may transmit natural language responses directly to the system 105 without recording or storing the responses on the client 105. In alternative scenarios the client 115 may process natural language responses directly without using the natural language engine 150, or may offload some of the natural language processing to the natural language engine 150 as needed, such as when a natural language response cannot be accurately or timely translated by the client 115.

It is noteworthy that the system 105 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the system 105 may include separately configured web servers.

According to some embodiments, the system 105 may include a cloud based computing environment that collects, analyzes, and publishes datasets. In general, a cloud-based computing environment is a resource that typically combines the computational power of a large grouping of processors and/or that combines the storage capacity of a large grouping of computer memories or storage devices. For example, systems that provide a cloud resource may be utilized exclusively by their owners, or such systems may be accessible to outside users who deploy applications within the computing infrastructure to obtain the benefit of large computational or storage resources.

The cloud may be formed, for example, by a network of web servers such as web server with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

The system 105 may execute the user interface module 125 to generate a customer survey. The details of the customer survey in regard to questions, response input mechanisms and overall survey aesthetics are defined by the provider. As used herein a provider may include a merchant or other commercial establishment, entity, or individual that provides a service or product to a customer. By way of example, a provider may include a car dealership. Aspects of the provider's business may be the subject of one or more surveys. For example, the dealership may be interested in determining consumer sentiment regarding the vehicles they purchase or test drive. Other aspects may include dealership service and maintenance quality, customer service quality, employee behaviors, and so forth. Virtually any aspect of a dealership that can be quantitatively or qualitatively measured may be the subject of one or more questions in a survey.

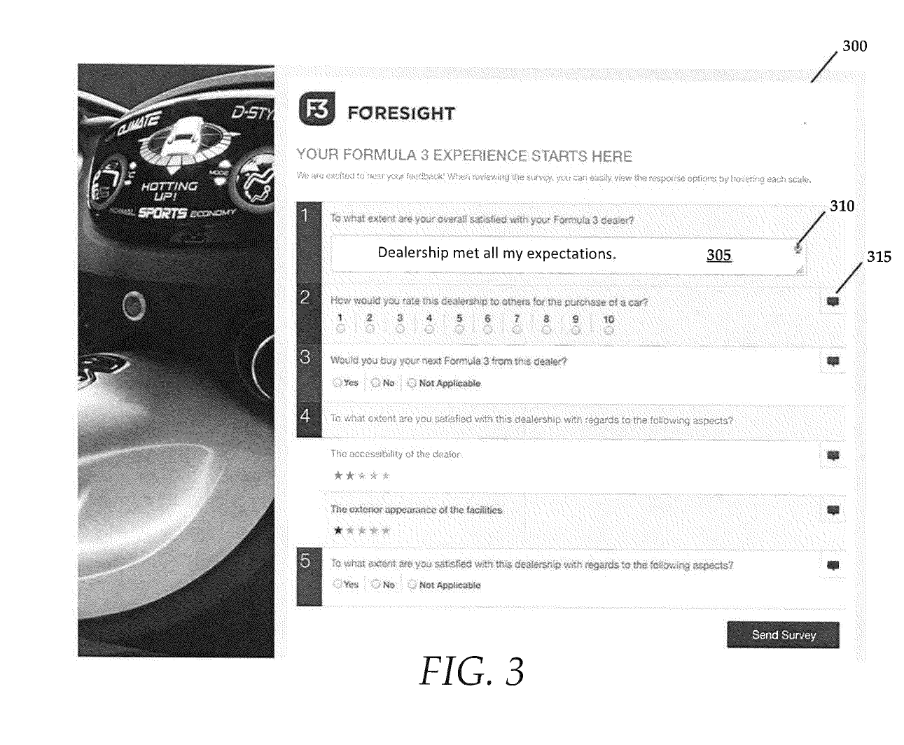

FIG. 2 illustrates an exemplary GUI layer 200 that is placed upon an underlying survey GUI 300 (see FIG. 3). The layer 200 includes instructions or indicia that provide descriptions for the customer as to how to use certain survey tools. For example, the instructions may inform the customer as to how to use various speech-to-text features embodied one the GUI. The customer can remove the layer 200 by clicking in the (x) at the top right corner of the layer 200, which exposes the survey GUI 300 that is described below.

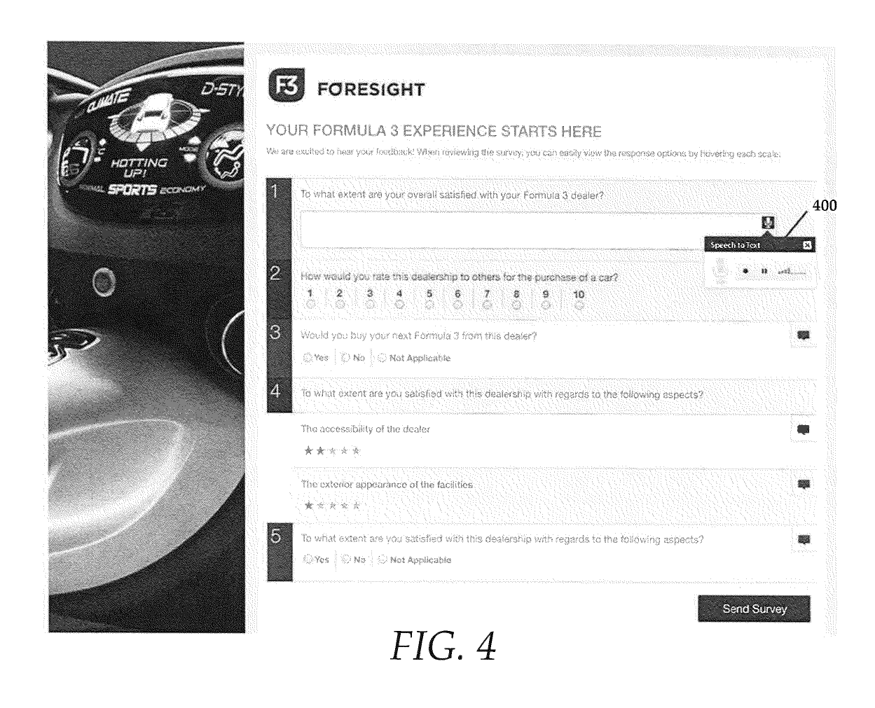

FIG. 3 illustrates an exemplary customer survey GUI 300 that includes a series of questions numbering from one to five. The first question relates to an overall satisfaction regarding a dealership. The question is provided with a text input box 305 which is configured to receive textual input from a user. The survey GUI 300 also includes a speech input interface 310 that is located within the text input box 305. Selection of the speech input interface 310 may cause the display of an interface tool panel 400 (see FIG. 4). In other embodiments, selection of the speech input interface 310 may instantiate a speech recording feature of the device on which the survey is being displayed. Natural language responses are recorded and transmitted to the system 105 for natural language processing via the natural language engine 150.

The system 105 may return a string of textual content back to the client 115 for display within the text input box 305. For example, the text input box 305 may be filled with text “Dealership met all my expectations”. If the customer is pleased with the speech to text translation the customer can move on to the next question. If the customer is displeased with the text translation the customer can use the speech input interface 310 to again capture a natural language response.

With regard to the other questions illustrated, each of these questions is provided with a speech input interface, such as speech input interface 315, which allows the customer to input a natural language response to a question, as well as provide a selectable response. For example, with respect to question two, the customer may select, on a scale from one to ten, a radio button associated with a rating that relates to how the dealership compares to other dealerships with regard to purchasing a car.

Advantageously, while a question may be associated with a plurality of selectable responses for ease of use, the selectable responses may not provide the customer with a means for communicating their customer experiences in an effective manner. Thus, the natural language response is coupled with the question to ensure that customers have the ability to address issues that would not be captured if only a selectable response was chosen.

Additionally, the response selected by the customer to a specific question may prompt the survey application to request that the customer provide a more specific response using the speech-to-text tool. For example, if the customer selects a value of one to four in response to question two, the customer may be prompted to create spoken response that provides the dealership with feedback regarding why the customer indicated that the dealership had a relatively poor rating.

In some instances, the system 105 may transmit back to the client 115 a sentiment associated with their natural language response. Using the sentiment value calculated for the customer, the survey application may automatically select one of the radio buttons that corresponds to the sentiment of the customer. For example, if the customer inputs a natural language response that is overwhelmingly positive, the system 105 may determine that the sentiment is positive and assign a value to the sentiment of the customer. Using this assigned value the survey application may select an appropriate radio button, such as nine or ten. Details regarding the determination of sentiment values for a natural language response by the system 105 will be provided in greater detail below.

As mentioned above, FIG. 4 includes the GUI of FIG. 3 with an interface tool control 400 displayed. The interface tool control 400 allows the customer to record, pause, replay, and adjust the volume of their spoken input. Allowing the customer to preview their spoken input ensures that recordings of high quality are transmitted to the system 105. Also, the customer can re-record their spoken input to ensure that their response includes their desired content.

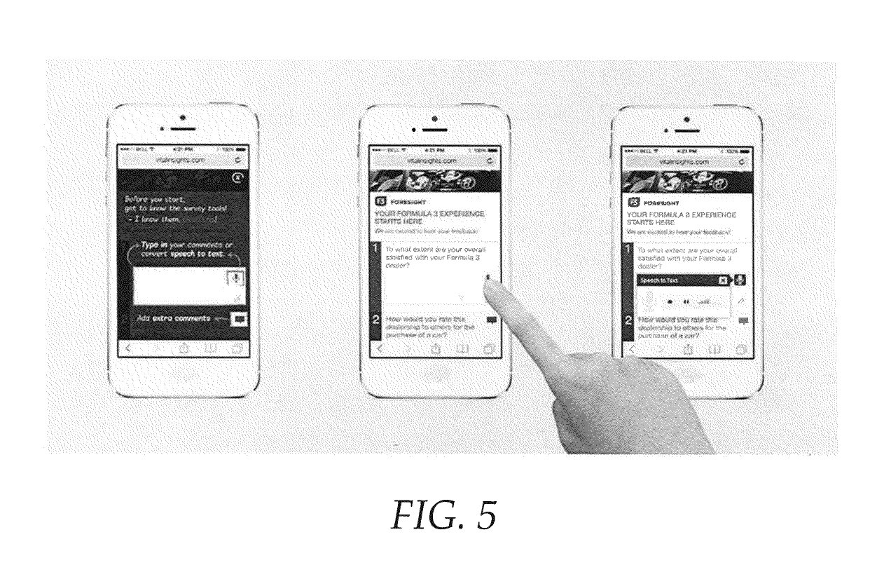

FIG. 5 illustrates the GUIs of FIGS. 2-4, displayed in a mobile format on a mobile device.

FIG. 6 is a GUI in the form of a provider dashboard 600. The dashboard 600 displays metrics and analytics determined from a plurality of customer surveys for a car dealership. The dashboard 600 includes a plurality of key performance indicator (KPI) graphics. For example, a KPI 605 related to new surveys indicates a number of newly completed surveys for the dealership. A KPI 610 of sales experience indicates a number of responses from surveys that implicate sales experiences. A KPI 615 of service experience represents a number of responses from surveys that implicate service experiences, while KPI 620 is related to certified pre-owned (CPO) experiences. A hot alert KPI 625 may indicate a number of surveys or responses to survey questions that are indicative of negative customer experiences as determined by the system 105.

The system 105 may allow a provider to select all negative survey responses, all positive survey responses, responses implicating service and maintenance, customer service, sales, and other measurable aspect of a car dealership. One of ordinary skill in the art will appreciate that the measurable aspects of each provider may vary according to the needs of the provider, such as the products and services they provide to their customers.

The dashboard 600 may also include graphics such as survey type graph 630 that graphically illustrates the various types of surveys used by the dealership. A customer score graph 635 illustrates metrics such as total users, active users, and survey downloads. These metrics are displayed graphically such that a number count for each of the above metrics is displayed with respect to time (in months). The dealership can easily determine how the above described metrics change over time.

Donut chart 640 is a representation of aggregate numbers of sentiment values calculated for survey responses, including those with sentiment levels determined from natural language responses. In this example, a 92% value is calculated as from a sum of the positive and neutral survey responses. The dealership can set goals or benchmarks as desired. For example, the dealership may specify that the sum of all positive and neutral surveys must be at or above 95%, otherwise a message may be displayed that the dealership is not meeting or exceeding their specified goal.

Word cloud 645 includes a graphical representation of keywords extracted from natural language responses received by the system 105. To create the word cloud, the system 105 may determine a frequency of occurrence of each of these keywords. Using the frequency of occurrence values, the system 105 may display words that occur frequently more prominently than words that occur less frequently in the natural language responses. In some embodiments, the words in the word cloud 645 may be selected by a user. In response, the system 105 may display surveys and/or specific responses that include the selected keyword.

A survey response table 650 may also be associated with dashboard 600. The table 650 includes individual rows corresponding to individual customers who completed surveys. For example table entry 655 includes a survey response from a customer who was determined by the system 105 to have a 100% satisfied sentiment for a service related survey. The entry 655 includes a customer comments section 660 that comprises not only the text response translated from a natural language response, but also a replay interface 665 that allows the dealership to listen to the audio recording of the natural language response.

With respect to the calculation of sentiment values for a survey or an individual survey response, the system 105 may utilize both responses received by customers choosing selectable responses, as well as natural language responses. A sentiment value may alternatively only include a sentiment value derived from a natural language response. In determining a sentiment value for a natural language response, the system 105 may begin by extracting keywords from a natural language response. It will be understood that the system 105 may utilize the natural language engine 125 to perform the natural language processing methods described herein.

The system 105 may ignore irrelevant words such as conjunctions, and focus on words that are associated with a sentiment, such as love, appreciate, good, best, outstanding, hate, dislike, poor, and so forth. The system 105 may also evaluate phrases in addition to keywords. For example, the system 105 may look for phrases such as “needs improvement” and “could have been better” in determining an overall sentiment value for a response. The system 105 may also identify proper names and titles, such as employee names, company titles such as “service department manager” and so forth. When the system 105 locates a name or a title in a response, the system 105 can tag the response with the identified name, which allow for these responses to be returned as a search result when the identified name/title is used in a query.

In addition to keywords the system may determine punctuation marks that are indicative of sentiment such as an exclamation point. The system 105 may also identify non-standard characters input into a text interface such as smiley faces or other emotion conveying characters such as “:)”, “:(”, “:̂|”, or a whole host of additional characters.

When calculating a sentiment value, the system 105 may utilize a frequency of occurrence calculation for keywords or phrases. For example, the system 105 may determine that the phrase “was pleased” occurred three times within the same response. The system 105 may assign a sentiment to the response of “positive” based upon the recurring presence of this phrase in the response.

A sentiment value for a response can be expressed with words such as positive, negative, neutral, or other similar sentiment. In other instances, a sentiment value may be expressed as a numerical value. For example, the sentiment value may range from zero to 100 with 100 being perfectly positive and zero being completely negative. A score of 50 would indicate neutrality. The numerical value may be calculated by assigning keywords specific values. For example, the word “outstanding” may have a value of 100, while “okay” may have a value of 55. The system 105 may calculate an average of the summation of values for each keyword in the response to calculate an overall sentiment value. The system 105 may also calculate an overall sentiment value for the survey itself, which may be an averaged value of the sum of the sentiment values for each response in a survey. Thus, sentiment values can be determined for individual responses to questions or for an aggregation of each question in a multi question survey.

Also, each of the questions may be assigned a weight that represents an importance of the question. For example, a question relating to an overall positive or negative experience of a customer may be weighted more highly than questions about comparatives with other dealerships. An example of weighting includes the system 105 multiplying each raw sentiment value with a coefficient. For example, the question associated with overall satisfaction may be multiplied by a coefficient of 0.8 while the question associated with comparative satisfaction may be multiplied by a coefficient of 0.4. The sum and average of these weighted values can then be calculated by the system 105. The example is provided to explain the concept of weighting and averaging of sentiment values and is not intended to be limiting with regard to how the system 105 can calculate or assign sentiment values related to survey responses. One of ordinary skill in the art will appreciate that other methods for calculating or determining customer sentiment may also likewise be used in accordance with the present technology.

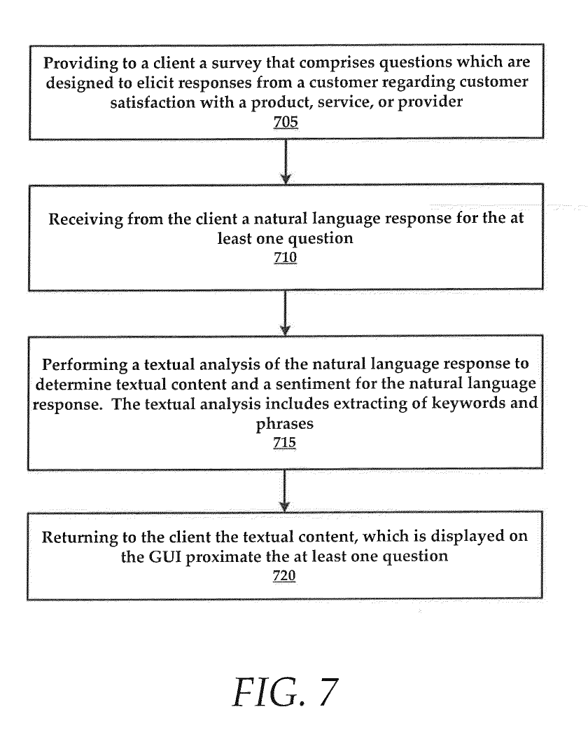

FIG. 7 is a flowchart of an exemplary method for processing natural language survey responses. As mentioned above, this method may be executed by a survey response system 105 that comprises a processor and a memory for storing logic. The processor executes the logic to perform the method. In some embodiments, the method includes providing 705 to a client 115 a survey that comprises questions which are designed to elicit responses from a customer regarding customer satisfaction with a product, service, or provider.

It will be understood that the survey includes a graphical user interface (GUI) for displaying the questions of the survey. In some instances, the GUI comprises a speech input interface for at least one question. In other embodiments, the GUI includes a speech input interface for each question in the survey.

Next, the method includes the system 105 receiving 710 from the client a natural language response for the at least one question. Again, the client 115 may record the natural language response when a customer clicks on the speech input interface on the GUI, which launches a voice recording feature on the client 115.

After receiving the natural language response, the method includes the system 105 performing 715 a textual analysis of the natural language response to determine textual content and a sentiment for the natural language response. The textual analysis includes extracting of keywords and phrases. The process may also include looking for text input into a text box. Thus, rather than (or in addition to) parsing a natural language response, the method may include determining keywords in text content typed into the GUI. In addition to keywords the system may determine punctuation marks that are indicative of sentiment such as an exclamation point. The system 105 may also identify non-standard characters input into a text interface such as smiley faces or other emotion conveying characters such as “:)”, “:(”, “:̂|”, or a whole host of additional characters.

A sentiment may be determined for the response or the survey overall. Again, the sentiment may be a value such as a description (e.g., positive, negative, and neutral) or a calculated value as described above.

Additionally, the method includes the system 105 returning 720 to the client 115 the textual content, which is displayed on the GUI proximate the at least one question. For example, the textual content may be displayed in a text interface that is disposed below or adjacent to the speech input interface as shown in FIGS. 2-4.

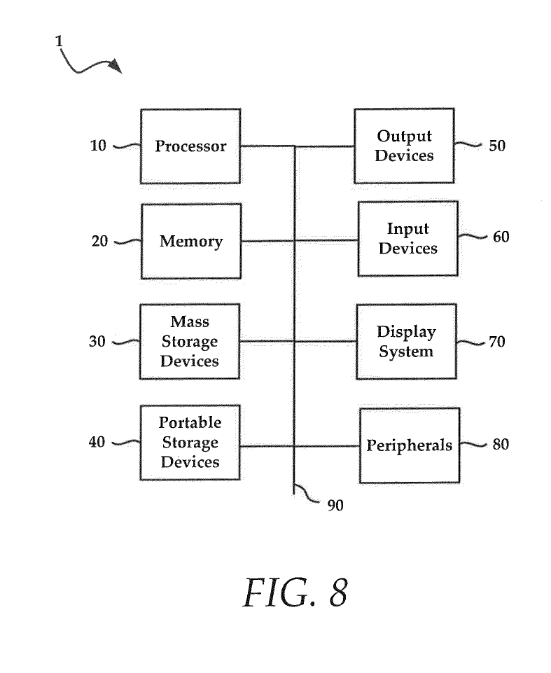

FIG. 8 illustrates an exemplary computing device 1 that may be used to implement an embodiment of the present systems and methods. The system 1 of FIG. 8 may be implemented in the contexts of the likes of computing devices, networks, servers, clients, nodes, systems (such as the survey response system 105), or combinations thereof. The computing device 1 of FIG. 8 includes a processor 10 and main memory 20. Main memory 20 stores, in part, instructions and data for execution by processor 10. Main memory 20 may store the executable code when in operation. The system 1 of FIG. 8 further includes a mass storage device 30, portable storage device 40, output devices 50, user input devices 60, a display system 70, and peripherals 80.

The components shown in FIG. 8 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 8. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 8 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 8 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for processing natural language survey responses using a survey response system that comprises a processor and a memory for storing logic, the processor executing the logic to perform the method, comprising:
providing to a client a survey that comprises questions which are designed to elicit responses from a customer regarding customer satisfaction with a product, service, or provider, wherein the survey includes a graphical user interface (GUI) for displaying the questions, the GUI comprising a speech input interface for at least one question;
receiving from the client a natural language response for the at least one question;
performing a textual analysis of the natural language response to determine textual content and a sentiment for the natural language response; and
returning to the client the textual content, which is displayed on the GUI proximate the at least one question.

2. The method according to claim 1, further comprising generating a provider dashboard that includes a representation of the sentiment for the at least one question.

3. The method according to claim 2, wherein the provider dashboard comprises a representation of a calculation of a plurality of sentiment values calculated for a plurality of customers.

4. The method according to claim 2, further comprising extracting words from textual content of a plurality of natural language responses and generating a word cloud from the textual content.

5. The method according to claim 4, wherein the word cloud is displayed on the provider dashboard.

6. The method according to claim 2, further comprising displaying the textual content determined from the natural language response on the provider dashboard.

7. The method according to claim 1, wherein each of the questions include a speech input interface configured to receive natural language responses, further wherein textual content and a sentiment are determined for natural language responses received for each of the questions.

8. The method according to claim 1, wherein the speech input interface is provided in addition to a response selection interface that includes a predetermined set of selectable responses, wherein the speech input interface provides a mechanism that allows the customer to augment a selected response of the set of selectable responses.

9. The method according to claim 1, wherein the speech input interface is provided in addition to a response selection interface that includes a predetermined set of selectable responses, further comprising automatically completing the response selection interface by selecting one of the set of selectable responses using the sentiment calculated for the natural language response.

10. The method according to claim 1, further comprising receiving feedback from the customer as to an accuracy of the textual content generated from the natural language response.

11. The method according to claim 10, further comprising receiving a supplemental natural language response when the customer indicates that the accuracy of the textual content is unacceptable.

12. A survey response system for processing natural language survey responses, the system comprising:
a processor;
a memory for storing logic, the logic being executed by the processor to perform operations comprising:
providing to a client a survey that comprises questions which are designed to elicit responses from a customer regarding customer satisfaction with a product, service, or provider, wherein the survey includes a graphical user interface (GUI) for displaying the questions, the GUI comprising a speech input interface for at least one question;
receiving from a client a natural language response for the at least one question;
performing a textual analysis of the natural language response to determine textual content and a sentiment for the natural language response; and
returning to the client the textual content, which is displayed on the GUI proximate the at least one question.

13. The system according to claim 12, wherein the processor further executes the logic to perform operations comprising generating a provider dashboard that includes a representation of the sentiment for the at least one question.

14. The system according to claim 13, wherein the provider dashboard comprises a representation of a calculation of a plurality of sentiment values calculated for a plurality of customers.

15. The system according to claim 14, wherein the processor further executes the logic to perform operations comprising extracting words from textual content of a plurality of natural language responses and generating a word cloud from the textual content.

16. The system according to claim 15, wherein the word cloud is displayed on the provider dashboard.

17. The system according to claim 14, wherein the processor further executes the logic to perform operations comprising displaying the textual content determined from the natural language response on the provider dashboard.

18. The system according to claim 12, wherein the speech input interface is provided in addition to a response selection interface that includes a predetermined set of selectable responses, wherein the speech input interface provides a mechanism that allows the customer to augment a selected response of the set of selectable responses.

19. The system according to claim 18, wherein the speech input interface is provided in addition to a response selection interface that includes a predetermined set of selectable responses, further comprising automatically completing the response selection interface by selecting one of the set of selectable responses using the sentiment calculated for the natural language response.

20. The system according to claim 12, wherein each of the questions include a speech input interface configured to receive natural language responses, further wherein textual content and a sentiment are determined for natural language responses received for each of the questions.

21. The system according to claim 12, wherein the processor further executes the logic to perform operations comprising receiving feedback from the customer as to an accuracy of the textual content generated from the natural language response; and receiving a supplemental natural language response when the customer indicates that the accuracy of the textual content is unacceptable.

22. A graphical user interface (GUI) generated by a computing device that comprises a processor and a memory for storing logic, the processor executing the logic to generate the GUI, the GUI comprising:
a series of survey questions designed to elicit responses that are indicative of customer experiences;
a speech input interface disposed in proximity to one or more of the series of survey questions, the speech input interface triggering a speech recording function of the computing device; and
a text display object associated with the speech input interface, the text display object providing textual content extracted from natural language responses recorded by the computing device.

23. The GUI of claim 22, wherein each of the series of survey questions comprises a speech input interface and each speech input interface comprises a text display object.
